(19) United States
(12) Patent Application Publication
(10) Pub. No.: US 2004/0061715 A1
(43) Pub. Date: Apr. 1, 2004

(54) System for the hierarchical organization of data

(76) Inventors: Edward Chu, Ashburn, VA (US); Steven Lin, Manassas, VA (US); Soy Chu, Reston, VA (US)

Correspondence Address: WENDEROTH, LIND & PONACK, L.L.P., 2033 K STREET N. W., SUITE 800, WASHINGTON, DC, 20006-1021, US

(21) Appl. No.: 10/259,467

(22) Filed: Sep. 30, 2002

(51) Int. Cl. G09G 5/00

(52) U.S. Cl. 345/709; 345/853

(57) ABSTRACT

An organizational system that can organize all of the parts associated with a given system down to a n^{th} or least/lowest replaceable/repairable component in a hierarchical manner and store the parts as a Bill of Materials (BOM). Each of the different parts listed in the BOM is associated with a unique part number. The organizational system can display or print the BOM such that the hierarchy between the parts is apparent so that the BOM can be used to build actual systems (assemblies).

### BACKGROUND OF THE INVENTION

1. Field of the Invention

The present invention relates to an organizational system (OS) that can be used to organize information related to interrelated parts of any of a number of different types of systems into a blueprint or Bill of Materials (BOM) using a computer. The OS organizes the interrelated parts in a hierarchy such that the relationship between the parts can be easily determined.

2. Description of the Prior Art

To date, many companies rely on hand written blueprints when building systems. However, these hand written blueprints are cumbersome and there is no efficient way in which to verify that the system has been built correctly using the hand written blueprint. Currently, the builder of the system will spot-check the actual system against the blueprint with the hope that any misplaced parts in the built system will become apparent during the spot-check.

### SUMMARY OF THE INVENTION

The present invention addresses the above-mentioned problem associated with hand written blueprints. The present invention relates to an OS that can organize all of the parts associated with a given system down to a n^{th} or least/lowest replaceable/repairable component in a hierarchical manner and store the parts as a Bill of Materials (BOM).

Each of the different parts listed in the BOM is associated with a unique part number. The organizational system can display or print the BOM such that the hierarchy between the parts is apparent so that the BOM can be used to build actual systems (assemblies).

Once a system is built using the BOM as a guide, the user of the OS can enter the asset numbers listed on each of the assets making up the actual system into the computer, via a keyboard, barcode reader or other means, so that the OS can compare each of the assets against the parts listed in the BOM. If an asset of the actual system is either misplaced or does not correspond with a part listed in the BOM; the OS notifies the user of this problem. In addition, if after the user has entered all of the assets making up the actual system into the computer and the OS determines that one or more of the assets listed in the BOM is missing from the actual system, the OS will also notify the user of these omissions. In this fashion, actual systems built from a BOM can be more efficiently verified for accuracy than by using traditional hand written blueprints. Further, each of the parts stored in the BOM can also be associated with a reference designator location for that part. The reference designator location provides more detailed information with regard to where the part is to be located within a next higher level part, so that the BOM can be used to create an actual assembly.

The OS of the present invention also allows an existing BOM to be modified in numerous ways. For example, parts previously listed in the BOM can be deleted, changed or have their position within the organizational hierarchy changed. Further, the part number associated with a given part in the BOM can be changed, as can the reference designator location associated with the part. The OS also allows for new levels within the existing hierarchy to be added, as well as allowing existing levels to be deleted.

In addition, the OS can also be used to import an existing parts list stored, for example, in a spreadsheet and use the parts list to create a BOM.

### BRIEF DESCRIPTION OF THE DRAWINGS

A better understanding of the invention will be obtained by reading the description of the invention below, with reference to the following drawings, wherein:

FIG. 1 is a block diagram of a system that may be programmed to implement the present invention;

FIG. 2 is an illustration of information that can be stored for a part;

FIG. 3 is an illustration of information that can be stored for an asset;

FIGS. 4(a)-(e) are a flow chart detailing the operations of the OS during the creation of a BOM;

FIG. 5 is an illustration of a BOM Configuration screen;

FIG. 6 is an illustration of a Root Part Number entry screen;

FIG. 7 is an illustration of a BOM Configuration screen;

FIG. 8 is an illustration of a screen inquiring as to whether or not a BOM should be saved;

FIG. 9 is an illustration of a screen prompting a user to enter a name under which the BOM should be saved;

FIG. 10 is an illustration of a BOM Configuration screen;

FIG. 11 is an illustration of a simple example of a BOM;

FIG. 12 is an illustration of a screen prompting a user to confirm the deletion of a BOM;

FIG. 13 is an illustration of a View BOM list screen;

FIG. 14 is an illustration of parts of a BOM displayed in a hierarchical fashion;

FIG. 15 is an illustration of a BOM Report list screen;

FIG. 16 is an illustration of a BOM Report screen;

FIGS. 17(a) and (b) are a flow chart detailing the operations of the OS during the creation of an assembly;

FIG. 18 is an illustration of a Build Assembly screen;

FIG. 19 is an illustration of a screen prompting a user to enter any asset numbers of children of an asset number previously entered;

FIG. 20 is an illustration of a View Assembly screen;

FIG. 21 is a flow chart detailing the operations of the OS during the validation of an assembly against a BOM;

FIG. 22 is an illustration of an Assembly Validation screen;

FIG. 23 is an illustration of a screen listing a number of discrepancies;

FIG. 24 is an illustration of a Select Assembly screen;

FIG. 25 is an illustration of a screen displaying parts of an assembly;

FIG. 26 is an illustration of a screen displaying a number of assemblies;

FIG. 27 is an illustration of an Assembly Report;

FIG. 28 is a flow chart detailing the operations of the OS during the importation of a BOM configuration;

FIG. 29 is an illustration of a screen prompting a user to enter a filename of a file containing BOM configuration data; and

FIG. 30 is an illustration of a template of a format of a database.

### DETAILED DESCRIPTION OF THE INVENTION

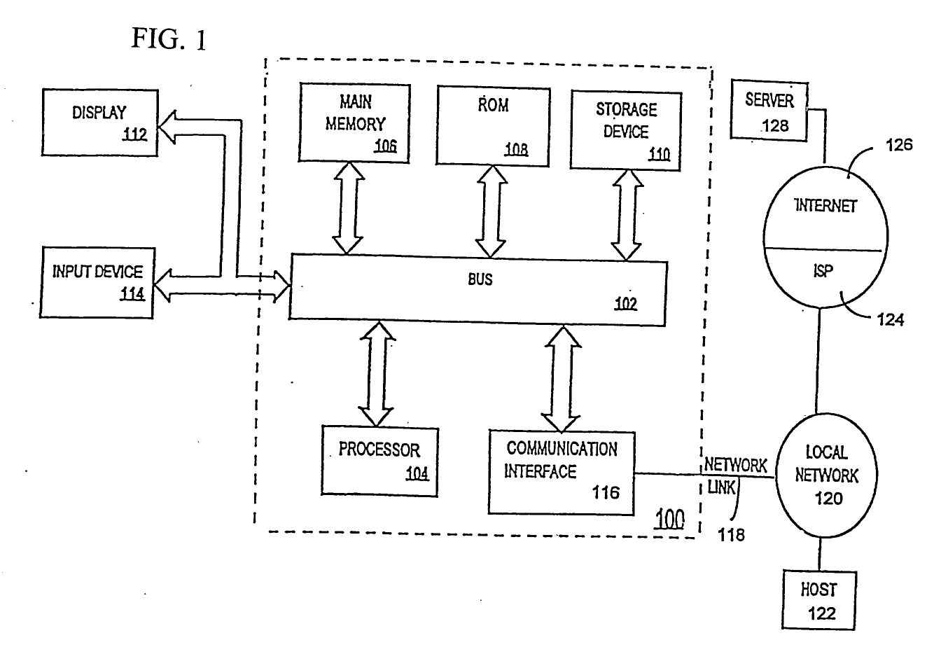

FIG. 1 is a block diagram that illustrates an exemplary computer system 100 upon which an embodiment of the invention may be implemented. The computer system 100 includes a bus 102 or other communication mechanism for communicating data, and a processor 104 coupled with the bus 102 for processing data. The computer system 100 also includes a main memory 106, such as a random access memory (RAM) or other dynamic storage device, coupled to the bus 102 for storing data and instructions to be executed by the processor 104. The main memory 106 also may be used for storing temporary variables or other intermediate data during execution of instructions to be executed by the processor 104. The computer system 100 further includes a read only memory (ROM) 108 or other static storage device coupled to the bus 102 for storing static data and instructions for the processor 104. A storage device 110, such as a magnetic disk or optical disk, is provided and coupled to the bus 102 for storing data and instructions. Furthermore, the processor 104 may additionally include a memory therein, e.g. a cache, for storing data and instructions to be executed by the processor 104.

The computer system 100 may be coupled via the bus 102 to a display 112, such as for example a cathode ray tube (CRT) or liquid crystal display (LCD), for displaying data to a user. An input device 114 is coupled to the bus 102 for communicating data and command selections to the processor 104. Non-limiting examples of an input device include a keyboard, scanner, mouse, trackball,joystick, lightpen, OCRs (Optical Character Recognition systems), voice-activation system, or the like. With regard to the use of a scanner, any type of scanning device could be used. For example, the scanner might be a INTERMEC™ SABRE MODEL 1551E™ hand-held scanner. Further, the input device 114 is not limited to only one input device and more than one of the examples listed above for the input device 114 can be concurrently connected to the processor 104 via the bus 102. Further, the computer system 100 can use any of a number of operating systems, such as DOS™, WINDOWS™, UNIX™, or LINUX™. However, the OS preferably operates on the computer system 100 running a WINDOWS™ operating system. The OS can be created will a number of different programming languages. However, an embodiment of the OS described herein was created using VISUAL BASIC™.

According to an embodiment of the invention, the BOM is produced by the computer system 100 in response to the processor 104 executing one or more sequences of one or more instructions (computer readable program code) of the OS contained in the main memory 106. Such instructions may be read into the main memory 106 from another computer-readable medium, such as the storage device 110. Execution of the sequences of instructions contained in the main memory 106 causes the processor 104 to perform the functions of the OS described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to the processor 104 for execution. Such a medium may take many forms, including but not limited to, non-volatile media, volatile media, and transmission media. Non-volatile media includes, for example, optical or magnetic disks, such as the storage device 110. Volatile media includes dynamic memory, such as the main memory 106. Transmission media includes coaxial cables, copper wire and fiber optics, including the wires that comprise the bus 102. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punch cards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions of the OS to the processor 104 for execution. For example, the instructions may initially be carried on a magnetic disk of a remote computer. The remote computer can load the instructions into its dynamic memory and send the instructions over a telephone line using a modem. A modem local to the computer system 100 can receive the data on the telephone line and use an infra-red transmitter to convert the data to an infra-red signal. An infra-red detector can receive the data carried in the infra-red signal and appropriate circuitry can place the data on the bus 102. The bus 102 carries the data to the main memory 106, from which the processor 104 retrieves and executes the instructions. The instructions received by the main memory 106 may optionally be stored on the storage device 110 either before or after execution by the processor 104.

The computer system 100 can also include a communication interface 116 coupled to the bus 102. The communication interface 116 provides a two-way data communication coupling to a network link 118 that is connected to a local network 120. For example, the communication interface 116 may be an integrated services digital network (ISDN) card or a modem to provide a data communication connection to a corresponding type of telephone line. As another example, the communication interface 116 may be a local area network (LAN) card to provide a data communication connection to a compatible LAN. Wireless links may also be implemented. In any such implementation, the communication interface 116 sends and receives electrical, electromagnetic or optical signals that carry digital data streams representing various types of data.

The network link 118 typically provides data communication through one or more networks to other data devices. For example, the network link 118 may provide a connection through the local network 120 to a host computer 122 or to data equipment operated by an Internet Service Provider (ISP) 124. The ISP 124 in turn provides data communication services through the world wide packet data communication network now commonly referred to as the “Internet” 126. The local network 120 and the Internet 126 both use electrical, electromagnetic or optical signals that carry digital data streams. The signals through the various networks and the signals on the network link 118 and through the communication interface 116, which carry the digital data to and from the computer system 100, are exemplary forms of carrier waves transporting the data.

The computer system 100 can send messages and receive data, including program code, through the network(s), the network link 118 and the communication interface 116. In the Internet example, a server 128 might transmit a requested code for an application program through the Internet 126, the ISP 124, the local network 120 and the communication interface 116.

The received code may be executed by the processor 104 as it is received, and/or stored in the storage device 110, or other non-volatile storage for later execution. In this manner, the computer system 100 may obtain application code in the form of a carrier wave.

The OS is also designed to interact with preexisting data structures. For example, the OS can interact with databases, preferably ACCESS™ by MICROSOFT™, and spreadsheets, preferably EXCEL™ by MICROSOFT™, that can be stored, for example, on the storage device 110 or the server 128. In an embodiment of the present invention, the OS is operable to interact with one or more databases that contain two categories of information. The first category of information relates to “parts” and the second category of information relates to individual “assets” which are each classified as one of the “parts.”

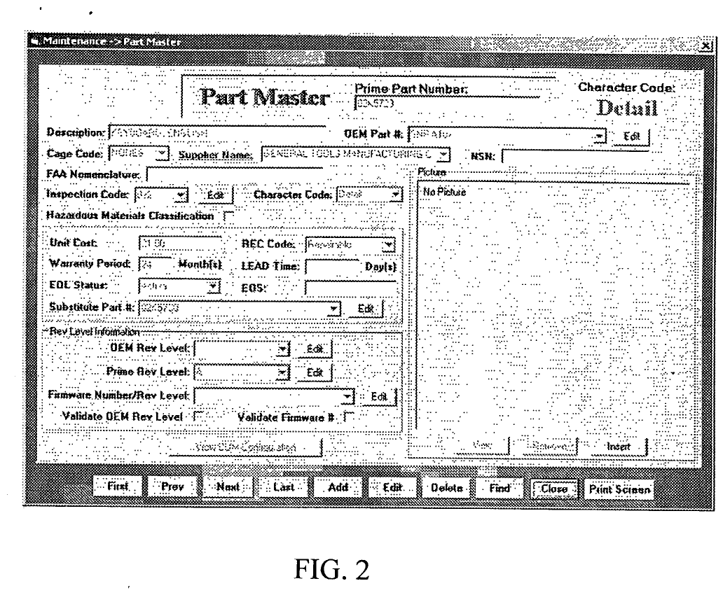

For each of the parts, the database can store information concerning the part in data fields. For example, some of the information that the database can include for a part is a prime (unique) part number for the part, a description of the part, an original equipment manufacturer's (OEM) part number for the part, which may or may not be the same as the unique part number, a cage code relating to supplier information regarding the part, a supplier name for the parts, an inspection code concerning inspection of the part, a unit cost for the part, a REC code indicating whether the part is repairable, consumable, non-repairable or expendable, LEAD time indication how far in advance this part should be ordered, the number of an acceptable replacement part, and a sample picture of the part (FIG. 2). However, this is not an exhaustive list of information that can be associated with a part, nor is all of this information required for each of the parts.

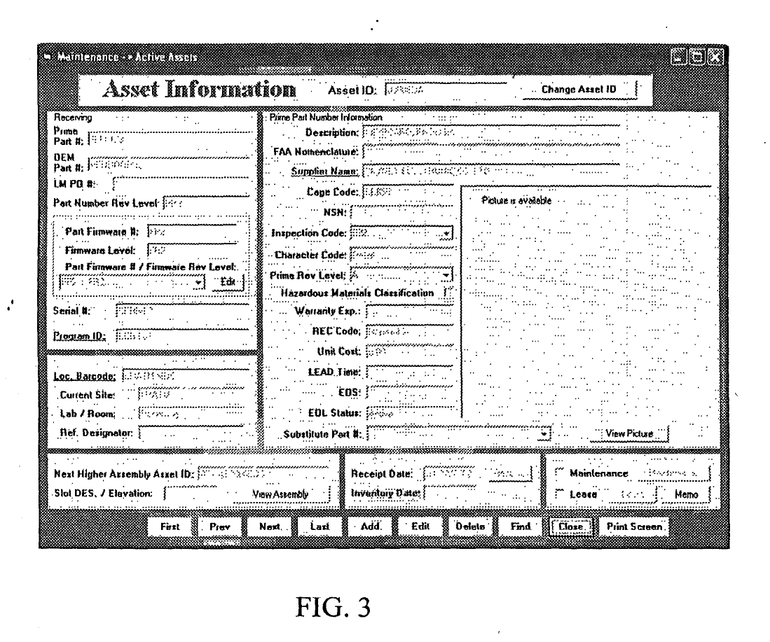

For each of the assets, the database can store information concerning the asset in data fields. For example, some the information that the database can include for an asset is a unique asset ID (asset number), a (prime) part number with which the asset is associated, an original equipment manufacturer's (OEM) part number for the asset, a purchase order (PO) number, a serial number of the asset, a current location (Loc. Barcode) of the asset, a current site of the asset, a current lab or room where the asset is located, a next higher asset number if the asset is a part of an assembly, elevation/slot designation (Slot Des./Elevation) which indicates where the asset resides in the assembly, if the asset does, in fact, reside in an assembly, a date when the item was received, and a date when the item was last inventoried (FIG. 3). However, this is not an exhaustive list of information that can be associated with an asset, nor is all of this information required for each of the assets.

From the above description of a part versus that of an asset, it is apparent that each of the assets is categorized as one of the parts. For example, a part might be, for example, a type of 500 megahertz computer chip and an asset categorized in the part (500 megahertz computer chip) might be a specific 500 megahertz computer chip. Further, there might be a number of additional 500 megahertz computer chips also associated with the part (a type of 500 megahertz computer chip). For this reason, each of the assets contains a data field in which the part number to which the asset is associated can be stored.

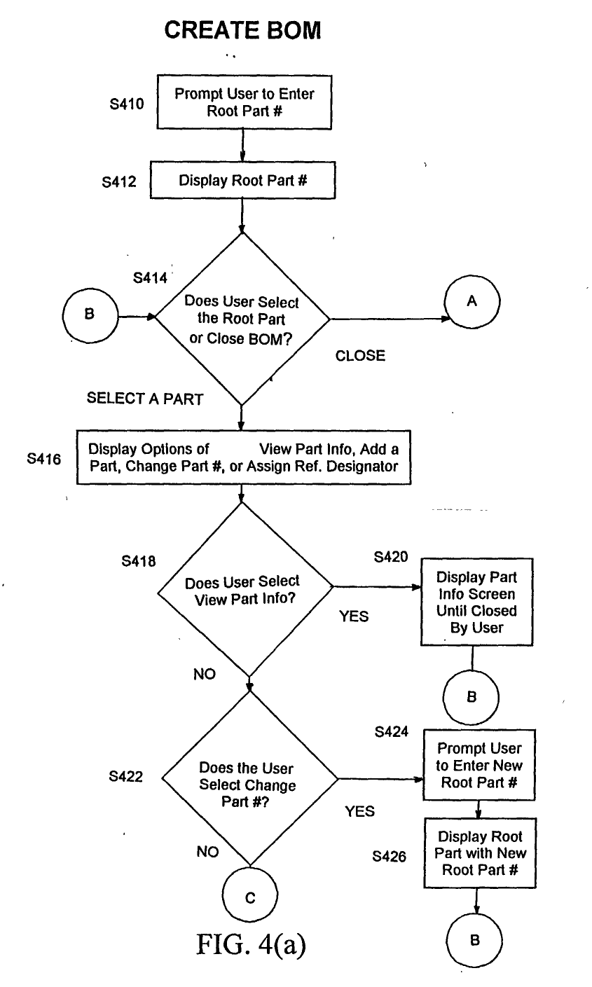

The OS operates to create a BOM based on the parts previously stored in the database as illustrated in the flow chart of FIGS. 4(a)-(e) described below.

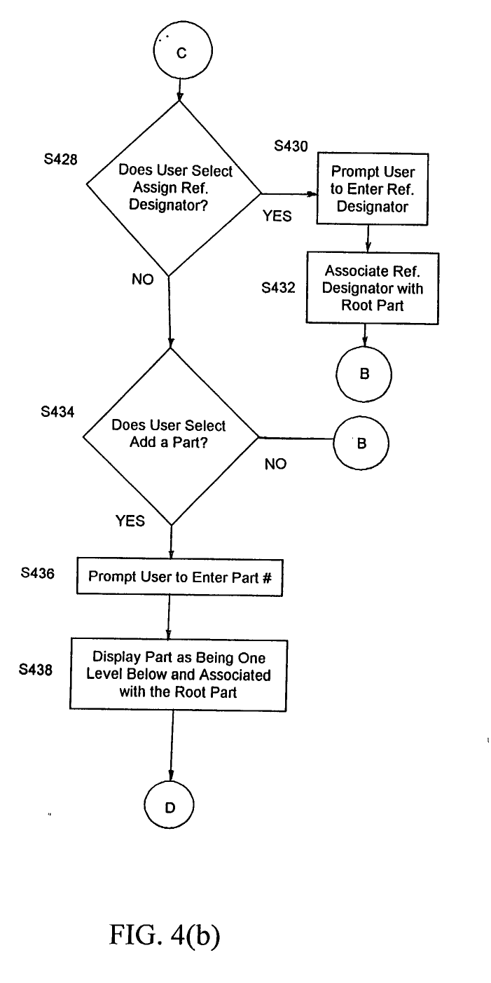

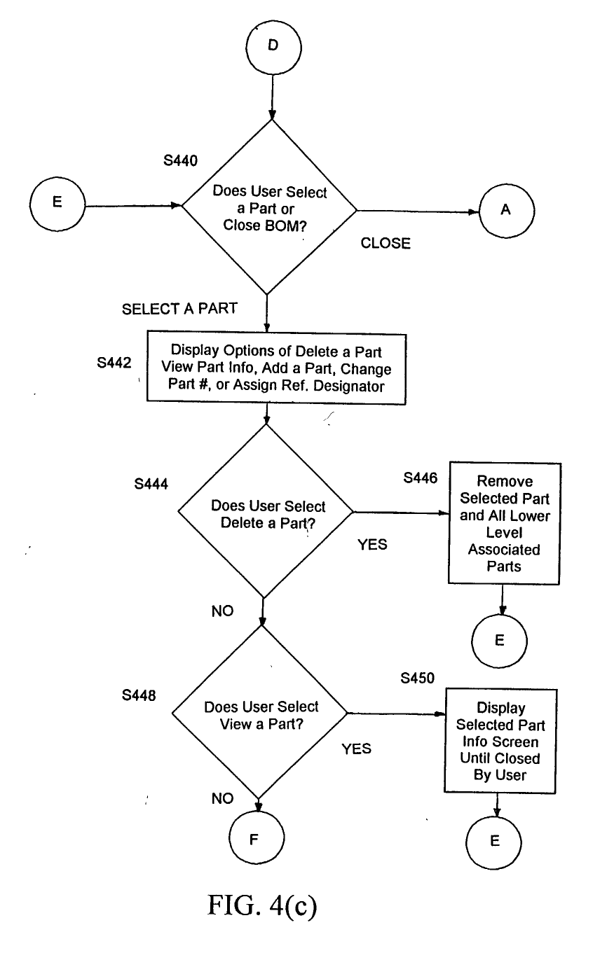

When a user wants to create a BOM, the user selects the BOM Configuration option in the OS using the input device 114 . Once the BOM Configuration option has been selected, the OS displays a BOM Configuration list screen (FIG. 5) listing all existing BOMs on the display 112 and providing a number of options, including New, Edit, Delete and Close. The user then selects the New option with the input device 114 and the OS displays a Root Part Number entry screen (FIG. 6) on the display 112 (S410). Once this screen is displayed, the user can enter a part number for the root part of the BOM that is being created with the input device 114. The root part is the highest level (level 0) part in the hierarchy of the BOM.

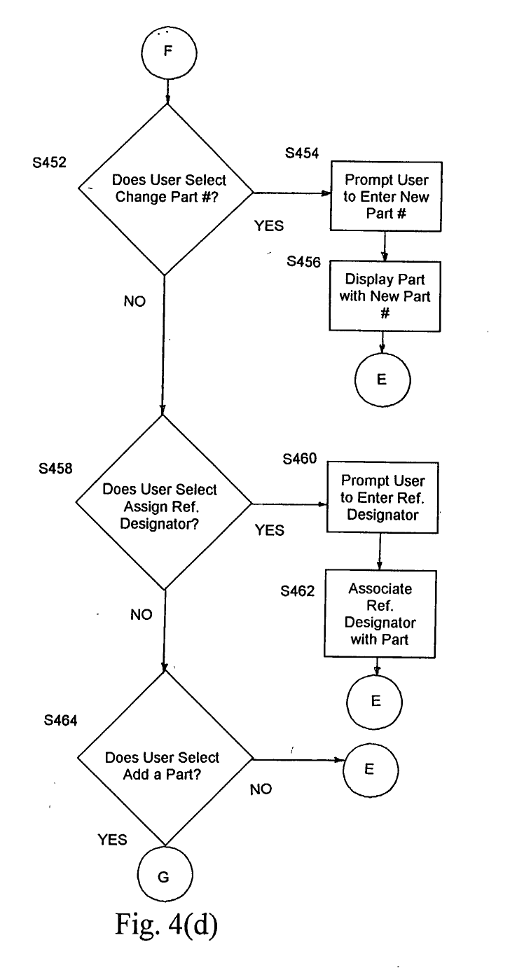

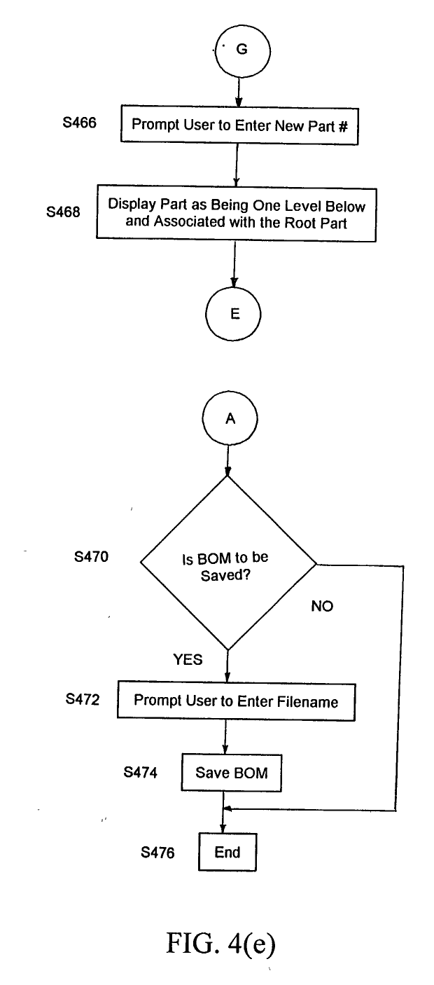

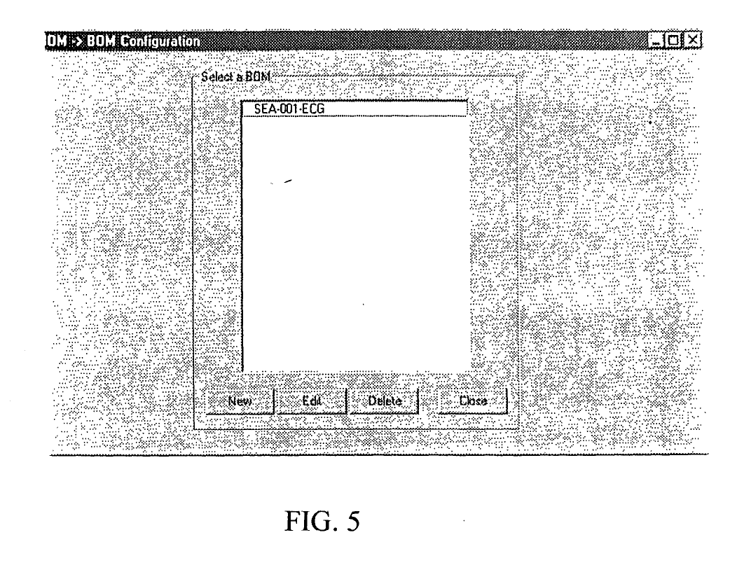

After the root part number has been entered, the OS displays a BOM Configuration screen (FIG. 7) with an icon labeled with the root part number being the only part illustrated in the BOM on the display 112 (S412). The OS then gives the user the options of highlighting and selecting the root part or closing the BOM (S414). If the user selects the Close option, the OS displays a screen (FIG. 8) asking the user if the BOM is to be saved (S470). If the user indicates that the BOM is to be saved, the OS then displays a screen (FIG. 9) prompting the user to enter a file name for the BOM (S472). Once the user enters the file name, the information is saved in a database located, for example, on the storage device 110 or the server 128 (S474). The operation of the OS regarding the creating of the BOM will then be complete (S476). The BOM will then be listed on the BOM Configuration list screen (FIG. 5). If the user indicates that the BOM is not to be saved, the OS will then jump directly to operation S476 without saving the BOM.

If the user highlights and selects the root part, the OS displays a number of options for the user on the display 112 (S416). These options include, Add a Part, Change Part Number, View Part Information and Assign Ref. Designator. If the user wants to view the information associated with the root part, the user selects the View Part Information option with the input device 114 (S418). When the View Part Information option is selected, the OS displays the Part Number screen (FIG. 2) for the root part on the display 112 (S420). As detailed above, the information illustrated in FIG. 2 is merely an example of the type of information that can be stored for a given part. When the user is done viewing the information, the user will close the information screen and the OS will return to operation S414.

If the user decides to change the part number of the root part, the user selects the Change Part Number option (S422). Once the Change Part Number option has been selected, the OS displays a Part Number entry screen similar to the Root Part Number entry screen (FIG. 6) originally displayed on the display 112 (S424). Once this screen is displayed, the user can enter a new part number to be associated with the root part via the input device 114. Once the new part number has been entered, the OS will associate the new root part number with the root part and the root part will be displayed on the display 112 (S426). The OS will then return to operation S414.

If the user wants to assign a Ref. designator to the root part, the user will select the Assign Ref. Designator option using the input device 114 (S428). Once this option is selected, the OS will display prompt the user to enter a Ref. Designator for the root part (S430). Once the Ref. Designator is entered, the OS will associate the Ref. Designator with the root part and the root part will be displayed on the display 112 (S432). The OS will then return to operation S414.

When the user wants to add a part to the BOM, the user selects the Add Part option via the input device 114 (S434) and the OS displays an Add Item screen on the display 112 prompting the user to enter the part number to be added (S436). Since the Add Part option was listed in response to the selection of the root part, which is the only part currently listed, the part number will be added and displayed one level (level 1) below the root part in the hierarchy of the BOM (S438). Therefore, this part number will be a child component of the root part. Once this first level 1 part has been added, the OS will now illustrate the icon representing the root part and a second icon representing the first level 1 part linked to the icon representing the root part in such a manner so as to indicate that the first level 1 part is a child of the root part on the display 112.

At this point, the OS waits for the user to highlight one of the parts illustrated on the display 112 or close the BOM (S440). If the user elects to close the BOM, the OS jumps to the Close BOM operation (S470) previously discussed. When the user highlights and selects one of the displayed parts, the OS displays the options of Add a Part, Change Part Number, View Part Information and Assign Ref. Designator, and Delete a Part. The options of View Part Information (S448 and S450), Change Part Number (S452-S456), Assign Ref. Designator (S458-S462), and Add a Part (S464-S468), and are similar to the options described above with the same names. The main difference being that the present options are not limited to just the root part and can, therefore, be performed with respect to any part displayed on the display 112.

If the user selects the Delete a Part option (S444), the OS removes the selected part from the BOM and any lower level parts that are listed from the selected part from the BOM (S446), the OS the OS then returns to operation S440 and waits for the user's next selection.

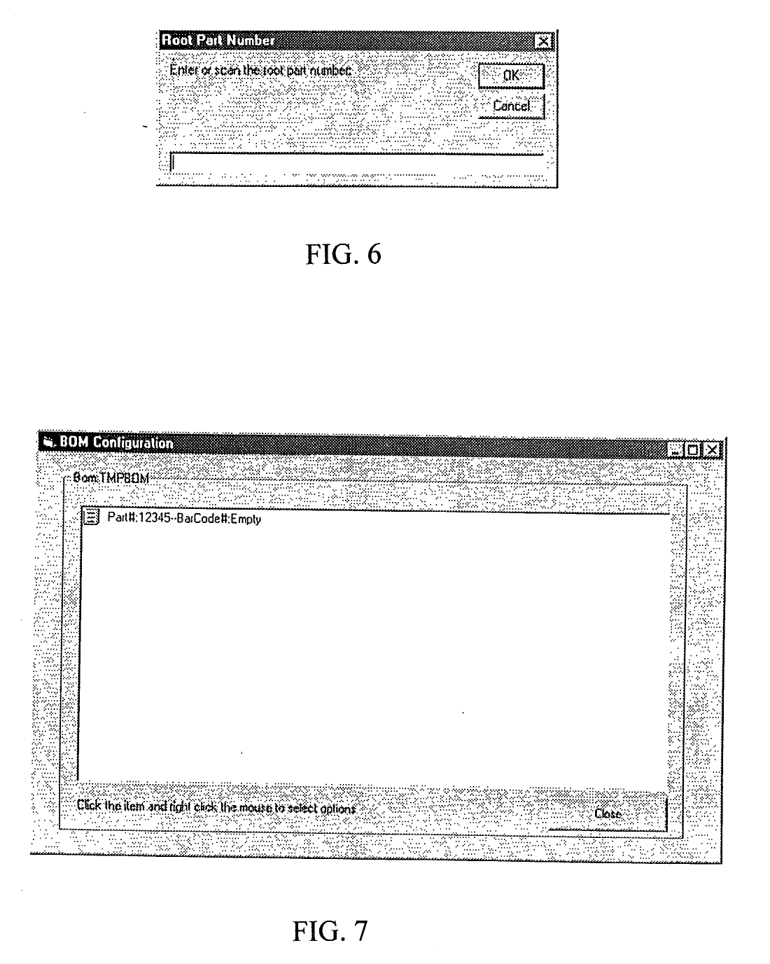

Once all of the parts are added for a given BOM, a BOM Configuration screen (FIG. 10) will display icons representing each of the parts in a hierarchical manner on the display 112, so that the parent/child relationship between the parts can be easily understood.

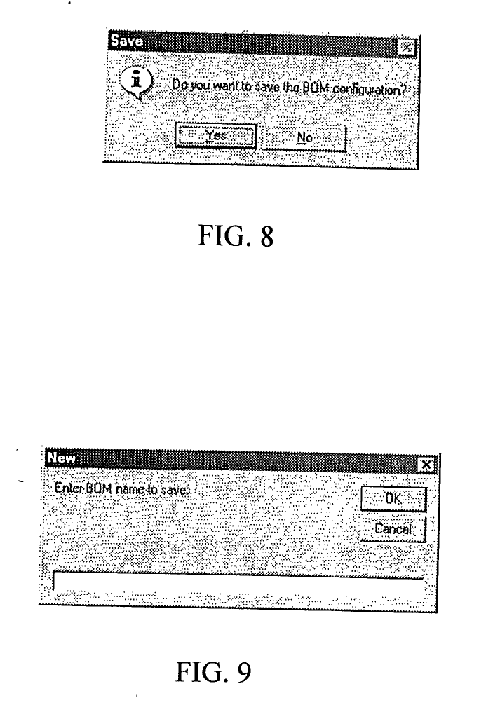

FIG. 11 illustrates a simple example of a BOM with a file name, Computer, created by the above-discussed procedure. In FIG. 11, the root part number is 500 which is a computer case. Therefore, the computer case is the level 0 part. The level 1 parts in this BOM are 1000 (motherboard), 2000 (power supply), 3000 (hard drive), and 4000 (CD ROM drive). As can be clearly seen from FIG. 11, part numbers 2000, 3000, and 4000 do not have any level 2 parts associated with them. However, part number 1000 (motherboard) has a number of associated level 2 parts. The level 2 parts associated with the mother board are 1100 (processor), 1200 (video card), 1300 (memory), 1400 (modem card), 1500 (sound card), and 1600 (processor fan). Further, part number 1000 has some level 3 parts located under part number 1300. The level 3 parts, 1310 (memory chip) and 1310 (memory chip), are two of the same “part” (i.e. being from the same classification).

Further, if the user assigns a Ref. Designator to any of the level 1, 2 and 3 parts, this Ref Designator would be helpful in detailing where exactly these lower level parts fit in their respective parent parts. For example, the Ref. Designator for each of the level 1 parts could indicate where in the computer case these parts are to be placed.

Based on the above description of FIG. 11, it is apparent how the BOM created by the OS organizes the parts in a hierarchical manner such that the BOM can be used to build actual computers. Each of the parts in the computer is associated with related parts in a top-down fashion.

If a user wants to edit an existing BOM, the user highlights one of the BOMs listed on the BOM Configuration list screen (FIG. 5) using the input device 114 and selects the Edit option. Once the Edit option is selected, the OS displays the BOM Configuration screen (FIG. 10) which shows all of the parts associated with the BOM in a hierarchical fashion as discussed above with regard to the creation of a new BOM. The user can then highlight any of the parts contained in the BOM and perform any of the same options that were available when the new BOM was created. These options include Add a Part, Change Part Number, View Part Information, Assign Ref. Designator, and Delete a Part. When the user is done editing the BOM, the user will also select the Close option in the same manner as discussed above with regard to the creation of the new BOM (FIGS. 8 and 9).

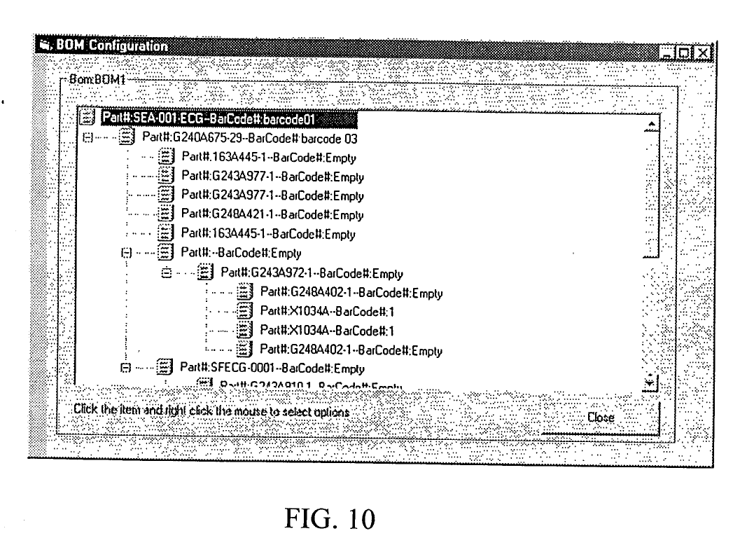

If the user wants to delete an existing BOM, the user highlights one of the BOMs listed on the BOM Configuration list screen (FIG. 5) with the input device 114 and selects the Delete option. Once the Delete option is selected, the OS will prompt the user to confirm that the BOM should be deleted (FIG. 12). If the user confirms the deletion of the BOM, it will be deleted and the BOM Configuration list screen (FIG. 5) will be updated so as to no longer list the deleted BOM.

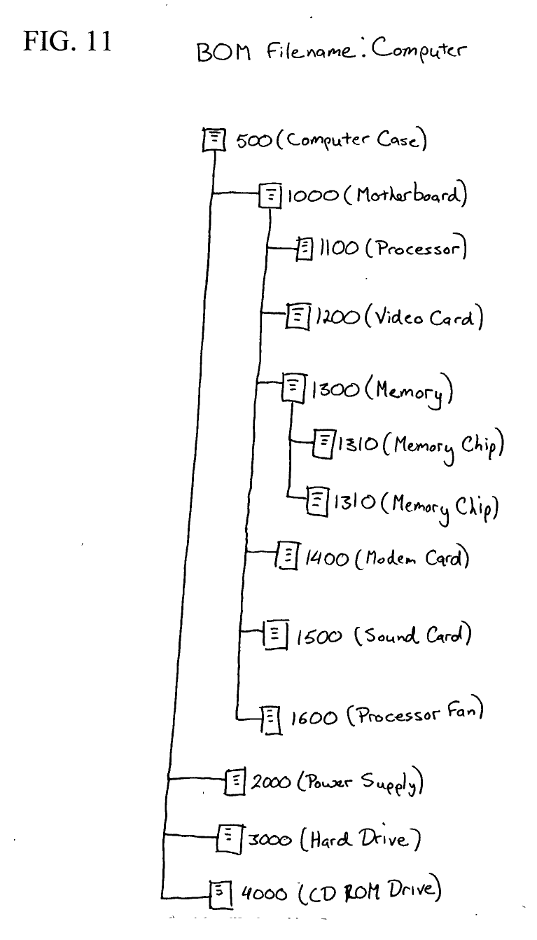

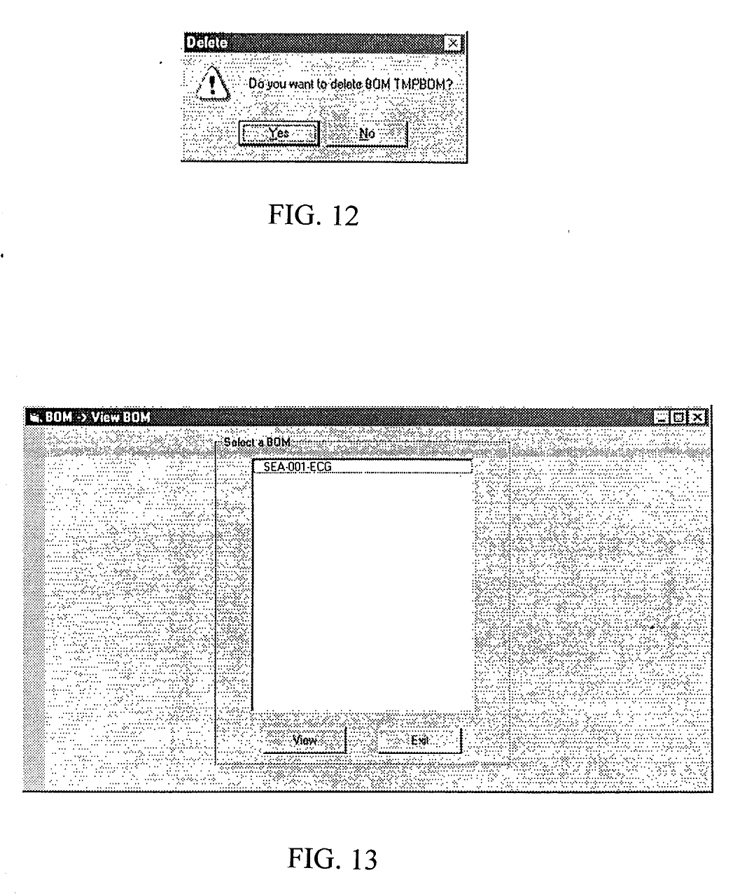

Another option available to the user of the OS is the ability to view an existing BOM. When the user selects the View BOM option via the input device 114, a View BOM list screen (FIG. 13) is displayed on the output 112 listing all of the BOMs. The user will then highlight the BOM to be displayed and select the view option with the input device 114. The OS will then display the parts of the BOM on the screen 112 in a hierarchical fashion similar to that in the BOM Configuration screen discussed above (FIG. 14).

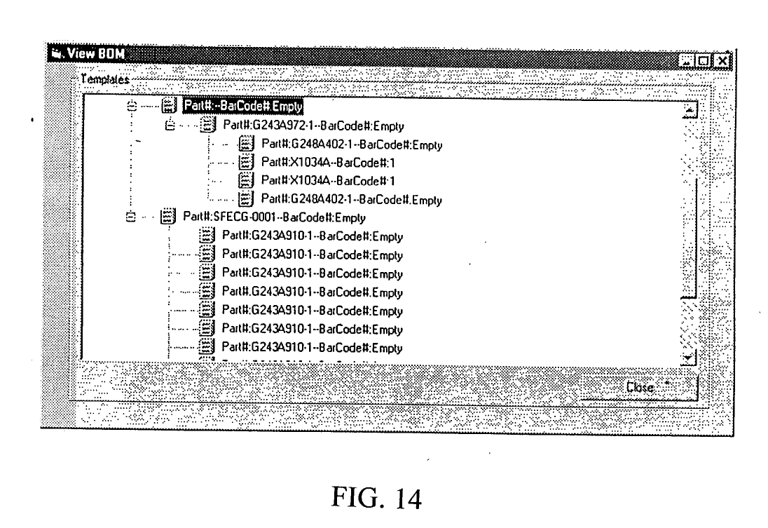

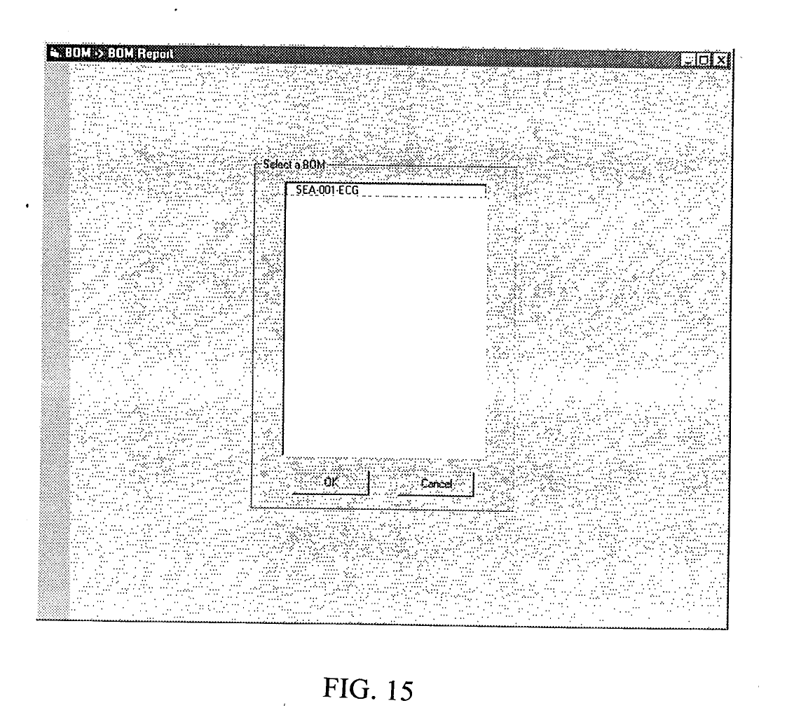

In addition, the user of the OS has the option of printing a BOM report for an existing BOM. When the user selects the BOM Report option with the input device 112, a BOM Report list screen (FIG. 15) is displayed on the output 114 listing all of the BOMs. The user will then select the BOM to be printed. The OS will then display the parts of the BOM in a BOM Report screen (FIG. 16) that is similar to the BOM Configuration screen (FIG. 10) discussed above, and will give the user the option of printing a copy of the BOM with the parts configured in the hierarchical fashion.

Once a BOM has been created, the user can use the BOM as a reference in order to assemble an actual system (assembly) from the BOM. For example, if the user wants to build a system, the user will first select either the View BOM option or the BOM Report option, depending on whether the user wants to view the BOM on the screen or print a hard copy of the BOM. Once the BOM is selected, the OS will display a graphical illustration of the BOM (FIG. 10) or print out the graphical illustration of the BOM (FIG. 16). The graphical illustration can show the user the interrelationship between the parts, as well as the parts numbers and any information associated with the parts. From this information, the user will be able to select the parts needed to build the system based on part numbers listed on each of the actual parts which correspond to the part numbers listed in the BOM. Further, the user will know how each of the parts fits with respect to the other parts due the hierarchical graphical illustration. If a part has special installation requirements, these requirements can be listed as the Ref. Designator of the respective part.

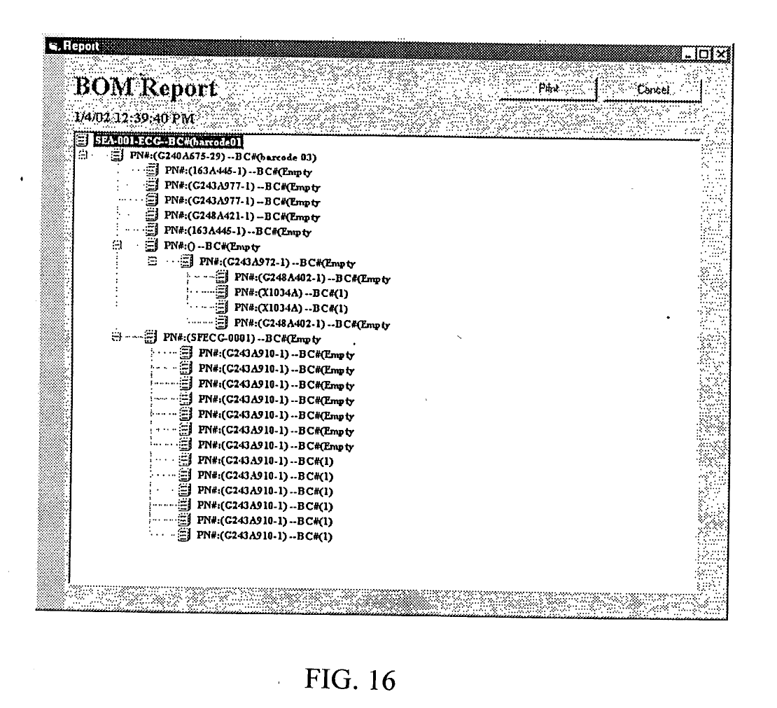

Once the user has finished assembling the system, the OS can be used to Validate that the actual system built by the user using specific assets was assembled correctly. The OS operates to create an assembly based on the assets previously stored in the database as illustrated in the flow chart of FIGS. 17(a) and (b) described below.

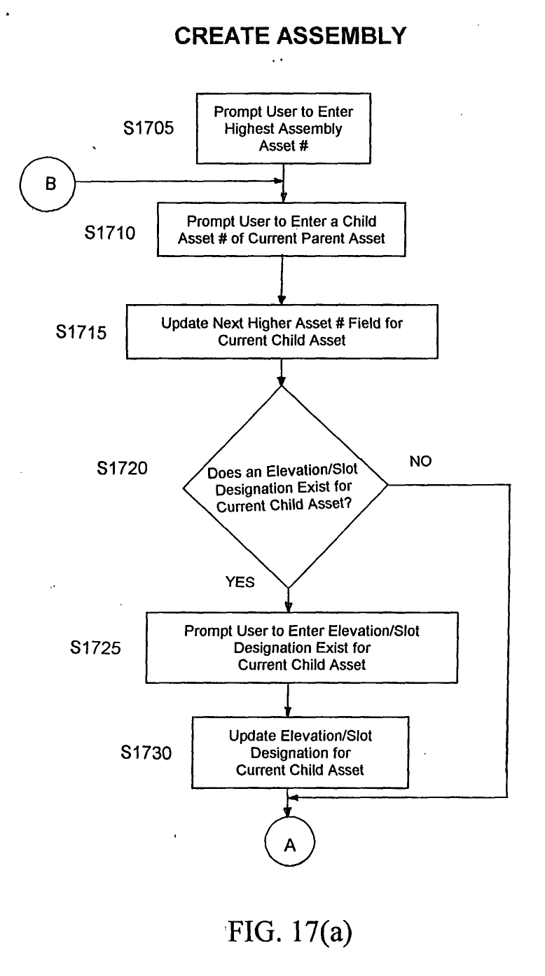

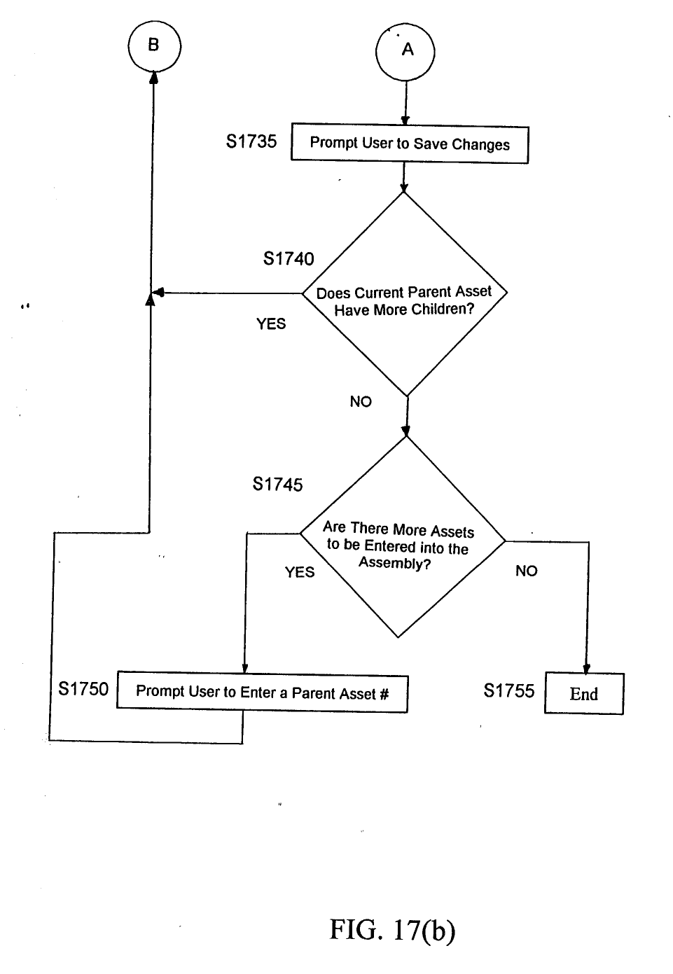

In order to make this validation, the user selects the Build Assembly option of the OS based with the input device 114. Once the user has made this selection, the OS will display a Build Assembly screen (FIG. 18) on the display 112 and prompt the user to enter the asset number of the highest level asset in the assembly (S1705). The user will then enter an asset number of the highest level asset in the assembly with the input device 114. Once the asset number has been entered, the OS will prompt the user to enter, with the input device 114, an asset number of a child of the current parent asset number (FIG. 19) (S1710). Once the user enters the asset number of the child, the OS updates the next higher asset field with the current asset number (S1715). Next, the OS queries the user as to whether or not elevation/slot designation information exists for this asset (S1720). If the user indicates that this information does exist, the OS prompts the user to enter this information (S1725). Once the user enters this information, the OS updates the (Slot Des./Elevation) field for this asset (S1730). If the user indicates that elevation/slot designation information does not exist for this asset, the OS skips operations S1725 and S1730.

Next, the OS prompts the user to save the changes that have been made for the current child asset (S1735). Once the changes have been saved by updating the database located in, for example, storage device 110 or the server 128, the OS will query the user as to whether the current parent asset number has more children (S1740). If the user indicates that the current asset does have more children, the OS returns to operation S1710. If the user indicates that the current asset does not have any more children, the OS queries the user as to whether or not there are any more assets to be entered in the assembly (S1745). If the user indicates that there are more assets to be entered into the assembly, the OS prompts the user to enter a parent asset number for the asset to be entered into the assembly (S1750) and the OS then returns to operation S1710. However, if the user indicates that there are no more assets to be entered into the assembly, the OS ends the operation (S1755). In this fashion, the user will be able to enter each of the asset numbers associated with the assets of an actual system. Once all of the asset numbers have been entered, the OS will be able to build the hierarchy of the assets of the assembly based on the information entered by the user. When the assembly is complete, the user will be able to save the assembly to, for example, the storage device 110 or the server 128.

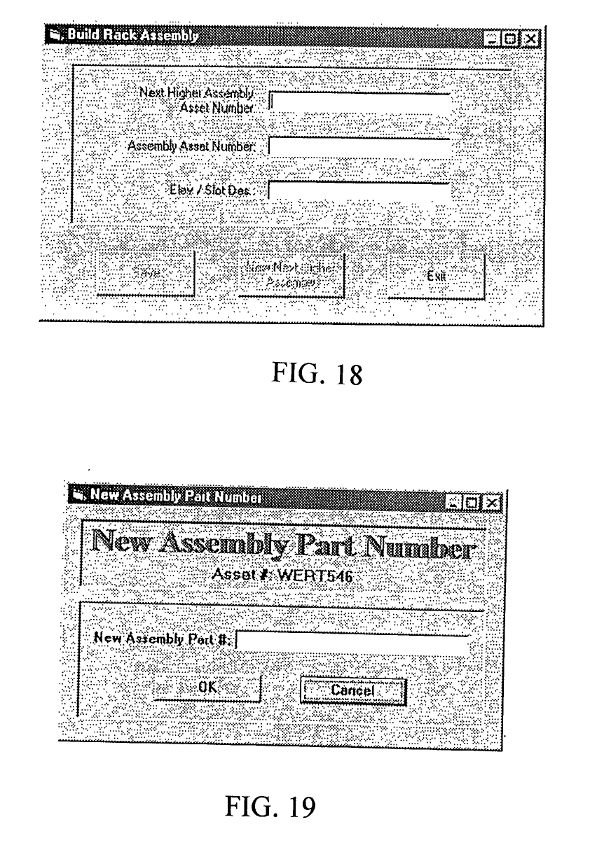

Once an assembly is complete, the user has the options of viewing or validating the assembly against a BOM. In order to view an assembly, the user selects the View Assembly option of the OS. The OS will then display a View Assembly screen (FIG. 20) listing all available assemblies on the display 112 from which the user can select. When the user highlights one of the assemblies and selects the View option, the OS will display the assembly in a hierarchical tree format similar to what is displayed in the BOM Configuration screen (FIG. 10) discussed above. The user can use this option to review the assembly for a system that has been built.

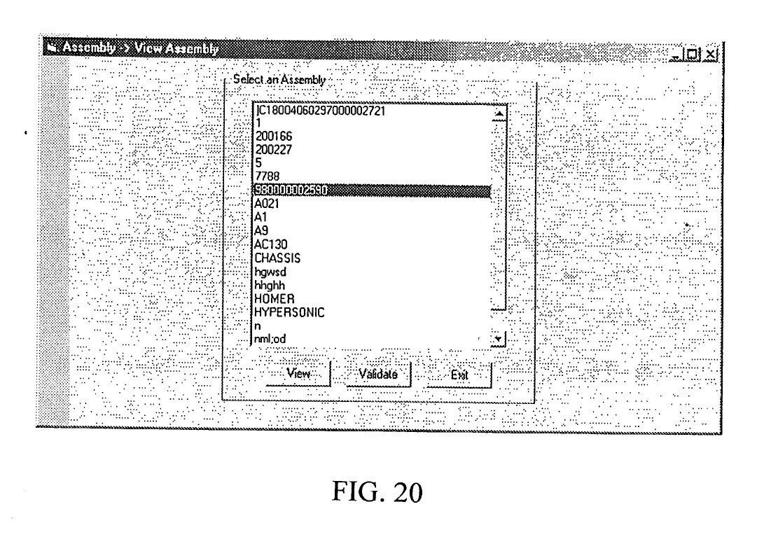

If the user wants to validate an assembly against a BOM, the OS operates as illustrated in the flow chart of FIG. 21 described below.

To validate an assembly, the user will highlight the relevant assembly for the system to be validated from the View Assembly screen (FIG. 20) and select the Validate option.

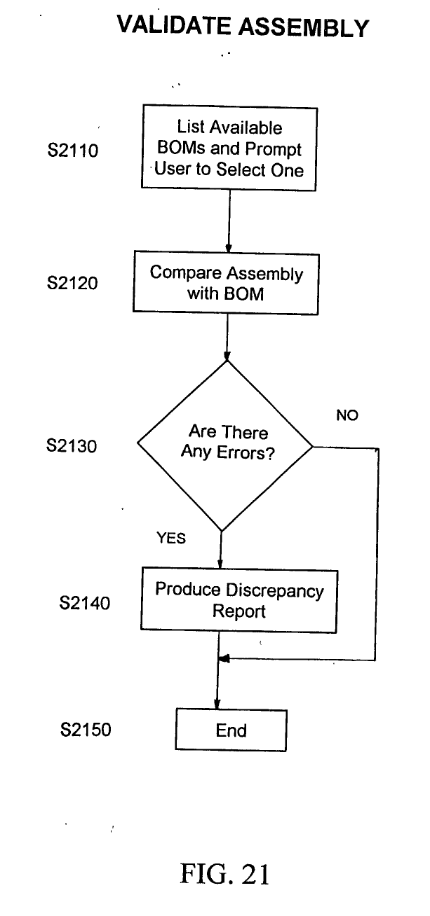

Once the user has selected the assembly to be validated, the OS will display an Assembly Validation screen (FIG. 22) on the display 112 that lists all the available BOMs (S2110). The user will then select the appropriate BOM for the assembly in question and the OS will then perform a comparison of the BOM with the assembly (S2120).

During the comparison of the assembly with the BOM, the OS compares the part number for each of the assets against the part numbers contained in the BOM to determine whether any assets are missing from the assembly or whether any assets are in the assembly that do not belong. In order to ensure that the assets all have the proper parent/child relationship, the OS references the next higher asset number listed for each of the assets in the assembly, determines the associated part number for the next higher asset (next higher part number), and compares this next higher part number of each of the assets against the BOM to ensure that all the assets are in the proper location within the assembly. Based on these operations by the OS, the OS can determine whether or not the assembly has the correct assets in the correct locations (S2130).

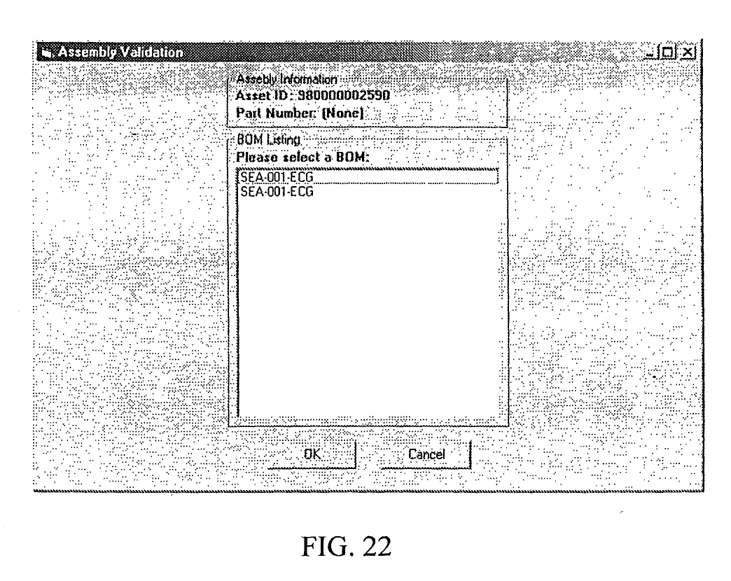

If any discrepancies are discovered, regarding missing assets, extra assets, or improperly located assets, the OS displays and/or prints a list of the discrepancies (Discrepancy Report) (FIG. 23) so that the user can correct the actual system represented by the assembly (S2140). Once the OS prints the Discrepancy Report, the operation ends (S2140). However, if the OS determines that no errors exist in the assembly, then no Discrepancy Report is generated and the operation ends (S2150).

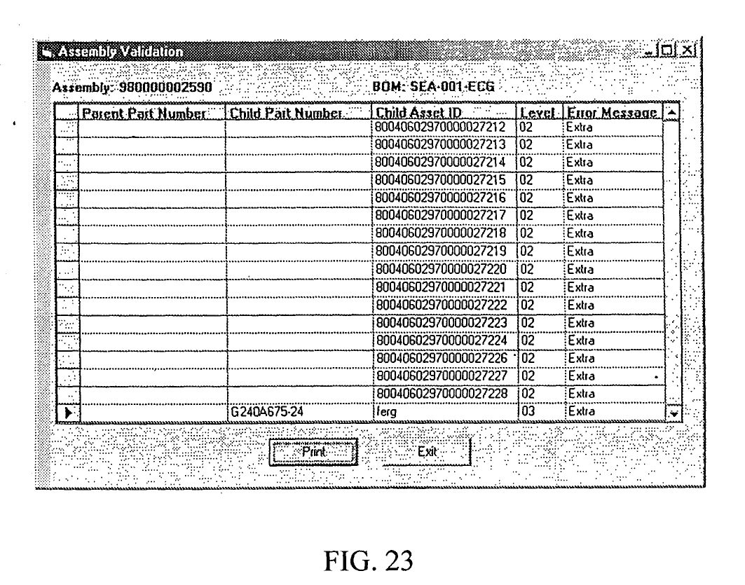

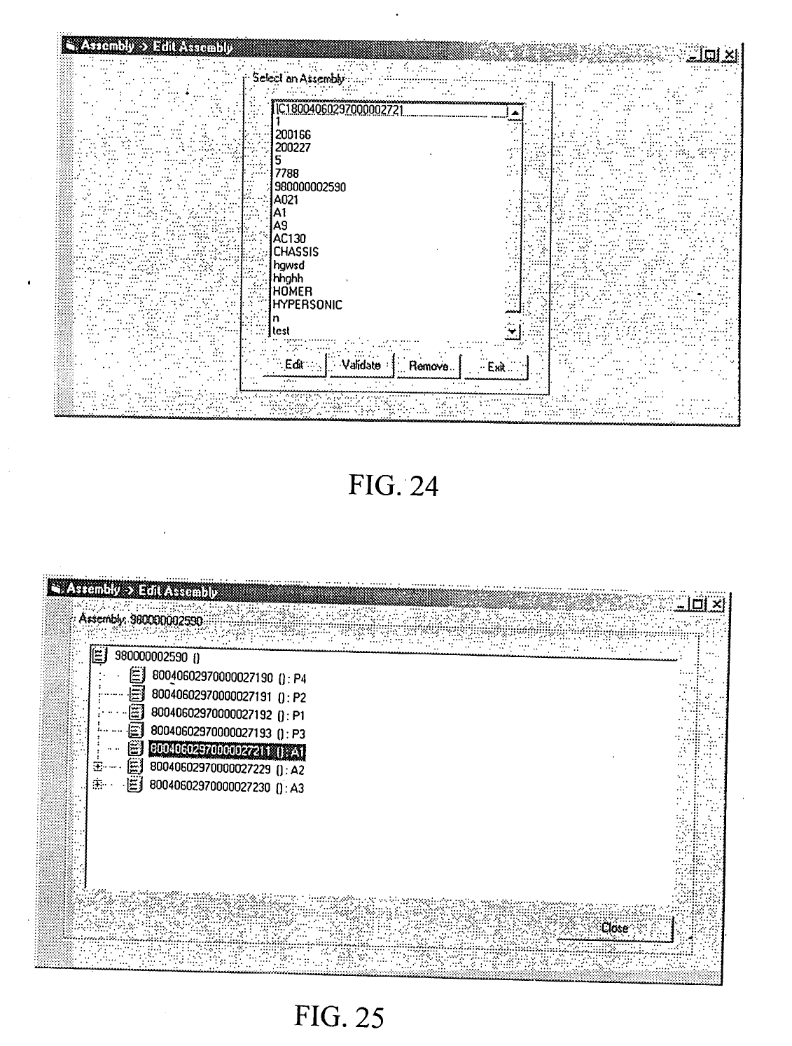

Another feature of the OS is the ability to edit an assembly. One reason that an assembly might need to be edited is that after the validation of the assembly, it might be determined that the assembly has a number of discrepancies. Based on these discrepancies, the user will most likely correct these problems in the actual system and will likewise correct the problems in the system's assembly. In order to edit an assembly, the user will select the Edit Assembly option and the OS will display a Select Assembly screen (FIG. 24) listing all available assemblies. The user will then chose the assembly to be edited. Once the user selects the assembly, the OS will display the assets of the assembly in a hierarchical fashion (FIG. 25) similar to that in the BOM Configuration screen (FIG. 10) discussed above.

Once the assembly is displayed by the OS, the user can highlight and select any of the assets listed on the assembly and the OS will provide the user with a number of options for the highlighted asset of the assembly. These options function in a similar fashion as the options available when creating and editing a BOM, but concern individual assets instead of parts. Some of the options are: Add an Asset, Change Asset Number, View Asset Information and Assign Elevation/Slot Designation (in place of Assign Ref. Designator), and Delete an Asset.

The user also has the option of removing an existing assembly by highlighting one of the assemblies listed on the View Assembly screen and selecting the Remove option. Once the Remove option is selected, the OS will prompt the user to confirm that the assembly should be removed. If the user confirms the removal of the assembly, it will be removed and the View Assembly screen will be updated so as to no longer list the removed assembly. This option is similar to the Delete option with respect to the BOM discussed above.

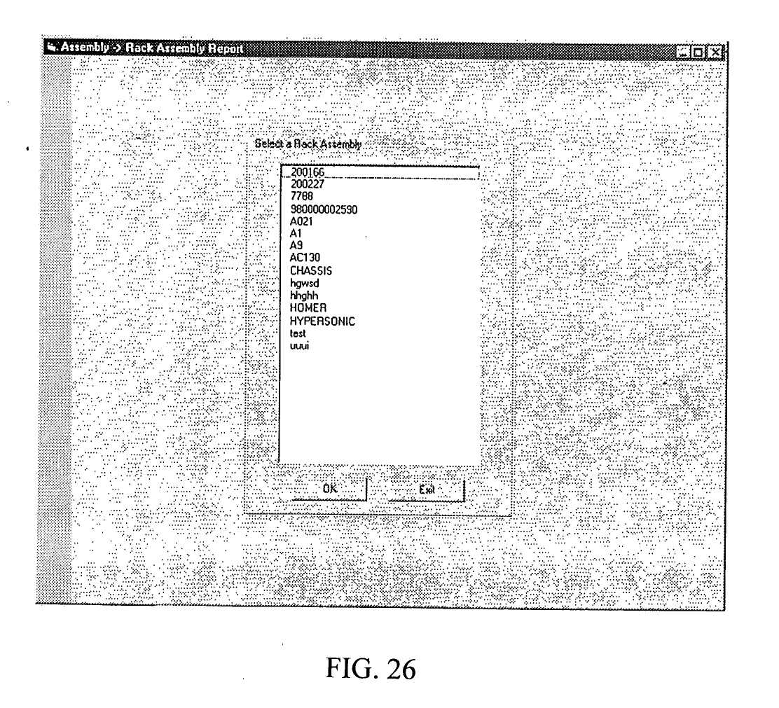

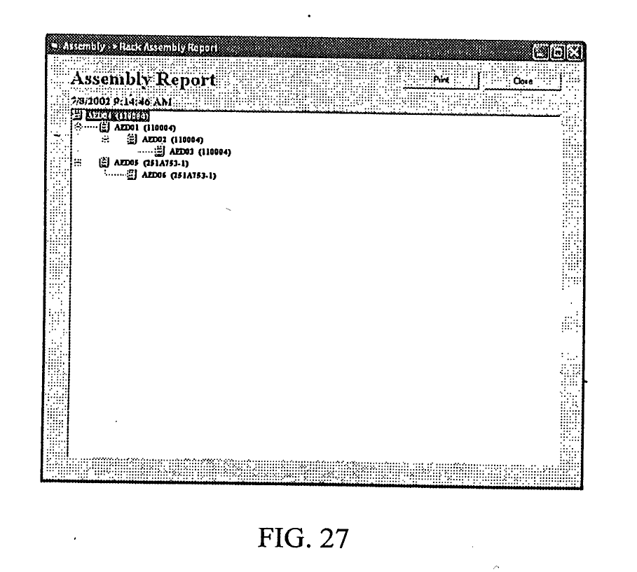

In addition, the user of the OS has the option of printing an assembly report for an existing assembly. When the user selects the Assembly Report option, the OS displays a screen listing all of the assemblies (FIG. 26). The user will then select the assembly to be printed and the OS will display an Assembly Report (FIG. 27) on the display 112. The Assembly Report (FIG. 27) illustrates the assembly in a hierarchical fashion similar to that in the BOM Configuration screen (FIG. 10) discussed above, and will give the user the option of printing a copy of the assembly with the parts configured in the hierarchical fashion.

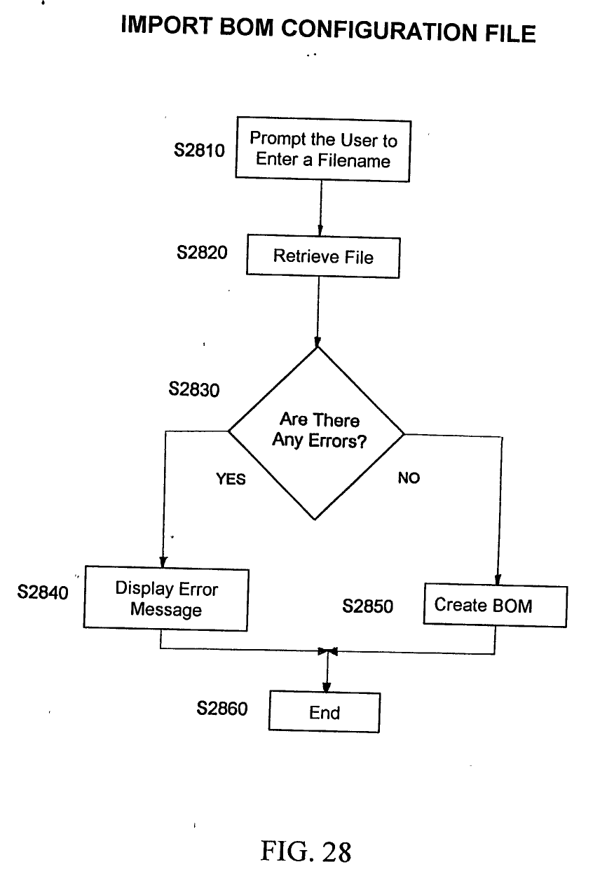

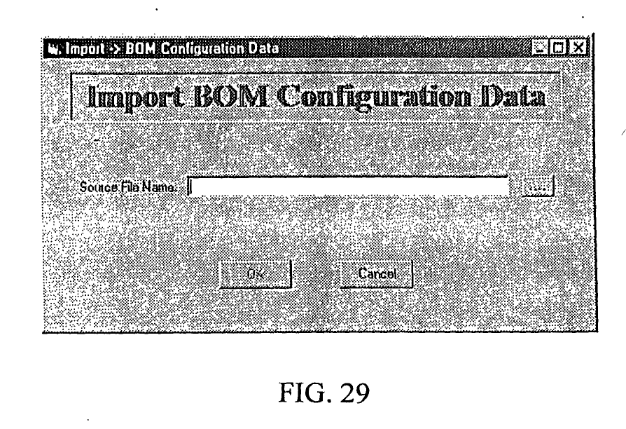

Another feature of the OS is that it can convert information stored in a file, for example, spreadsheet, into a BOM. In implementing this feature, the operation of the OS is illustrated in the flow chart of FIG. 28. To use this feature, the user will select the Import BOM Configuration Data option of the OS. The OS will then prompt the user to enter the name of a file containing the BOM configuration (FIG. 29) (S2810). The file could be, for example, a spreadsheet (for example, an EXCEL™ spreadsheet) containing the information to be imported. The OS then retrieves the file from the location where its stored (S2820). The spreadsheet can be stored at numerous locations. For example, the spreadsheet could be located at the storage device 110, the server 128, or a removable storage medium inserted into a corresponding drive in the computer system 100.

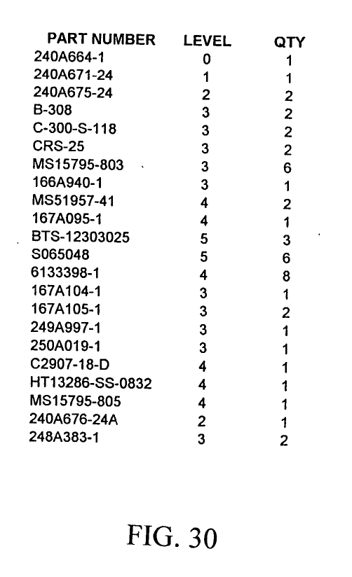

Once the file has been retrieved, the OS checks for errors in the information while importing the information (S2830). It is noted that for the OS to import all of the information correctly, the information in the spreadsheet must contain a specific format so that the OS will be able to properly create the hierarchy associated with the BOM. In order to do this, the OS associates certain fields in the spreadsheet as containing certain information, so that the OS can properly import and organize the information contained in the spreadsheet. For example, a template of the format of the database has all of the part numbers listed in a first column, the hierarchical level of the parts in the next column and the quantity of the parts in a last column (FIG. 30). With respect the hierarchical levels of the parts, the parts are listed so that parts with higher levels are children of parts with the next highest level listed above. When the parts are placed in the proper columns, the OS can import the information from the database and know how the parts are related.

If the OS determines that information in the file contains one or more errors, the OS displays an error message to the user indicating that there is a problem with the file (S2840). One of the problems that might occur is if the file contains two part numbers associated with level 0. Since level 0 is defined as the root part, of which there can be only one, the OS will detect this and indicate that the file contains an error However, if the file contains no errors, the OS creates the BOM from the information contained in the file (S2850). After the OS either displays the error message or creates the BOM, the operation is complete (S2860).

When a BOM is created by importing information from a database as described above, the user has the same options available as if the user had entered all of the parts of the BOM via the input device 114.

With regard to what type of systems the OS can create BOMs for, the possibilities are limitless with regard to the type and scale of the system. As an example of the vast variation of scale in which the OS can be utilized, the following are “systems” for which the OS could create a BOM. A first example of a BOM, with a filename of Office Building, could contain a part number for a building as its root (level 0) part, part numbers for the floors of the building as the level 1 parts, part numbers for the rooms on each of the floors as the level 2 parts, and so on. A second example of a BOM, with a filename of Automobile, could contain a part number for an automobile frame as its root (level 0) part, part numbers for the main components (i.e. engine, transmission. . . ) of the automobile as the level 1 parts, part numbers for the subcomponents of each of the components as the level 2 parts, and so on. A third example of a BOM, with a filename of Anti-lock Braking Controller, could contain a part number for a circuit board as its root (level 0) part, part numbers for the main logic components of the controller as the level 1 parts, part numbers for the microchips of each of the main logic components as the level 2 parts, and so on.

Based on the above description of the present invention, it is apparent that the OS provides a device by which BOMs can be created for any system that is arranged in a hierarchical fashion. The OS has almost unlimited flexibility and scalability so as to be able to create a BOM for any arrangement of parts that can be considered a system. Further, the OS has the ability to verify actual systems (assemblies) against the BOMS to insure that the systems are assembled correctly. This flexibility and scalability makes the OS vastly superior to a hand written blueprint.

What is claimed is:

1. A computer-implemented method of organizing parts in a hierarchy of levels as a bill of materials (BOM), said computer implemented method comprising:
receiving part number data of a root part corresponding to a highest part level of the hierarchy of levels;
displaying the root part as an icon;
receiving at least one additional part number data of at least one additional part corresponding to part at a level lower than the highest part level and associated with a part one level higher in the hierarchy of levels; and
displaying the at least one additional part as a child of an icon of the part one level higher.

2. A computer-implemented method of organizing parts in a hierarchy of levels as a bill of materials (BOM), said computer implemented method comprising:
prompting a user to enter a root part corresponding to a highest part level of the hierarchy of levels;
displaying the root part as an icon;
prompting the user to either close the BOM or select the root part;
if the user selects the close BOM option, closing the BOM;
if the user selects the root part as a selected part, displaying options of close BOM, view part information, change part number, assign reference designator, and add a part;
if the user selects the view part information option, displaying part information corresponding to the selected part;
if the user selects the change part number option, prompting the user to enter a new part number for the selected part and updating the selected part with the new part number;
if the user selects the assign reference designator option, prompting the user to enter a reference designator to be associated with the selected part;
if the user selects the add a part option, prompting the user to enter a new part number for a new part, and displaying the new part as an icon one level lower and associated with the icon for the selected part;
prompting the user to either close the BOM or select one of a plurality of displayed parts as the selected part;
if the user selects the close BOM option, performing said closing of the BOM;
if the user selects one of the plurality of displayed parts as the selected part, displaying the options of close BOM, view part information, change part number, assign reference designator, add a part; and delete a part for the selected part; and
if the user selects the delete a part option, deleting the selected part and any associated lower level parts of the selected part from the BOM.

3. A computer-implemented method according to claim 2, wherein said closing of the BOM comprises:
prompting the user as to whether or not the BOM is to be saved;
if the user indicates that the BOM is to be saved, prompting the user to enter a filename for the BOM and saving the BOM; and
if the user indicates that the BOM is not to be saved, closing the BOM without saving the BOM.

4. A computer-implemented method according to claim 2, wherein the part information includes a description of the part, an original equipment manufacturer's part number for the part, a cage code relating to supplier information regarding the part, a supplier name for the part, an inspection code concerning inspection of the part, a unit cost for the part, a REC code indicating whether the part is repairable, consumable, non-repairable or expendable, LEAD time indication how far in advance the part should be ordered, a number of an acceptable replacement part, and a sample picture of the part.

5. A computer-implemented method of organizing parts in a hierarchy of levels as a bill of materials (BOM), said computer implemented method comprising:
prompting a user to enter a filename of a spreadsheet containing a list of a plurality of parts, a quantity of each of the plurality of parts, and an associated hierarchal level of each of the plurality of parts;
checking the list of the plurality of part for errors;
if at least one error exists in the spreadsheet, displaying an error message;
if no errors exist, creating the BOM associating all of the plurality of parts in a hierarchy by associating each of the plurality of parts with at least one other of the plurality of parts based on the associated hierarchical level and an order in which the plurality of parts is listed in the list; and
displaying the plurality of parts in the hierarchy.

6. A computer-implemented method of verifying an assembly of a plurality of assets, said computer-implemented method comprising:
receiving a plurality of asset numbers, each of the asset numbers corresponding to one of the plurality of assets such that the plurality of asserts are arranged in a hierarchical order;
comparing a part number associated with each of the plurality of assets against a bill of materials having a plurality of part numbers in a hierarchy;
determining if any of the plurality of assets are inconstant with the plurality of parts in the BOM;
if any inconsistences exist, displaying the inconsistencies; and
if no inconsistencies exist, displaying no inconsistancies.

7. A computer program embodied on a computer readable medium for user with a computer, for organizing parts in a hierarchy of levels as a bill of materials (BOM), said computer program comprising:
computer readable program code operable to receive part number data of a root part corresponding to a highest part level of the hierarchy of levels;
computer readable program code operable to display the root part as an icon;
computer readable program code operable to receive at least one additional part number data of at least one additional part corresponding to part at a level lower than the highest part level and associated with a part one level higher in the hierarchy of levels; and
computer readable program code operable to display the at least one additional part as a child of an icon of the part one level higher.

8. A computer program embodied on a computer readable medium for user with a computer for organizing parts in a hierarchy of levels as a bill of materials (BOM) in a hierarchy of levels, said computer program comprising:
computer readable program code operable to prompt a user to enter a root part corresponding to a highest part level of the hierarchy of levels;
computer readable program code operable to display the root part and any other existing parts as icons;
computer readable program code operable to prompt the user to either close the BOM or select the root part as a selected part;
computer readable program code operable to close the BOM, if the user elects to close the BOM;
computer readable program code operable to display the options of view part information, change part number, assign reference designator, and add a part, if the user selects the root part as the selected part;
computer readable program code operable to display part information corresponding to the selected part, if the user selects the view part information option;
computer readable program code operable to prompt the user to enter a new part number for the selected part and update the selected part with the new part number, if the user selects the change part number option;
computer readable program code operable to prompt the user to enter a reference designator to be associated with the selected part, if the user selects the assign reference designator option;
computer readable program code operable to prompt the user to enter a new part number for a new part to be located one level below the level of the selected part and associated with the selected part, if the user selects the add a part option;
computer readable program code operable to prompt the user to select one of the displayed parts as the selected part or close the BOM;
computer readable program code operable to display options of view part information, change part number, assign reference designator, add a part; and delete a part, if the user selects one of the displayed parts as the selected part; and
computer readable program code operable to delete the selected part and any associated lower level part of the selected part from the BOM, if the user selects the delete a part option.

9. A computer program according to claim 8, wherein said computer readable program code operable to close the BOM comprises:
computer readable program code operable to prompt the user as to whether or not the BOM is to be saved;
computer readable program code operable to prompt the user to enter a filename for the BOM and save the BOM, if the user indicates that the BOM is to be saved; and
computer readable program code operable to close the BOM without saving the BOM, if the user indicates that the BOM is not to be saved.

10. A computer program according to claim 8, wherein the part information includes a description of the part, an original equipment manufacturer's part number for the part, a cage code relating to supplier information regarding the part, a supplier name for the part, an inspection code concerning inspection of the part, a unit cost for the part, a REC code indicating whether the part is repairable, consumable, non-repairable or expendable, LEAD time indication how far in advance the part should be ordered, a number of an acceptable replacement part, and a sample picture of the part.

11. A computer program embodied on a computer readable medium for user with a computer for organizing parts in a hierarchy of levels as a bill of materials (BOM) in a hierarchy of levels, said computer program comprising:
computer readable program code operable to prompt a user to enter a filename of a spreadsheet containing a list of a plurality of parts, a quantity of each of the plurality of parts, and an associated hierarchal level of each of the plurality of parts;
computer readable program code operable to check the list of the plurality of parts for errors;
computer readable program code operable to display an error message, if at least one error exists in the spreadsheet; and
computer readable program code operable to create the BOM of the plurality of parts in a hierarchy by associating each of the plurality of parts with at least one other of the plurality of parts based on the associated hierarchical level and an order in which the plurality of parts is listed in the list and to display the plurality of parts in the hierarchy, if no errors exist.

12. A computer program embodied on a computer readable medium for user with a computer for verifying an assembly of a plurality of assets, said computer program comprising:
computer readable program code operable to receive a plurality of asset numbers, each of the asset numbers corresponding to one of the plurality of assets such that the plurality of asserts are arranged in a hierarchical order;
computer readable program code operable to compare a part number associated with each of the plurality of assets against a bill of materials having a plurality of part numbers in a hierarchy;
computer readable program code operable to determine if any of the plurality of assets are inconstant with the plurality of parts in the BOM; and
computer readable program code operable to display the inconsistencies, if any inconsistences exist.

13. A computer system for organizing parts in a hierarchy of levels as a bill of materials (BOM), said computer system comprising:
means for receiving part number data of a root part corresponding to a highest part level of the hierarchy of levels;
means for displaying the root part as an icon;
means for receiving at least one additional part number data of at least one additional part corresponding to part at a level lower than the highest part level and associated with a part that is one level higher in the hierarchy of levels; and
means for displaying the at least one additional part as a child of an icon of the part one level higher.

14. A computer system for organizing parts in a hierarchy of levels as a bill of materials (BOM), said computer system comprising:
means for prompting a user to enter a root part corresponding to a highest part level of the hierarchy of levels;
means for displaying the root part and any other existing parts as an icons;
means for prompting the user to either close the BOM or select the root part as a selected part;
means for closing the BOM, if the user elects to close the BOM;
means for displaying the options of view part information, change part number, assign reference designator, and add a part, if the user selects the selected part;
means for displaying part information corresponding to the selected part, if the user selects the view part information option;
means for prompting the user to enter a new part number for the selected part and update the selected part with the new part number, if the user selects the change part number option;
means for prompting the user to enter a reference designator to be associated with the selected part, if the user selects the assign reference designator option;
means for prompting the user to enter a new part number for a new part to be located one level below the level of the selected part and associated with the selected part, if the user selects the add a part option;
means for prompting the user to select one of the displayed parts as the selected part or close the BOM;
means for displaying options of view part information, change part number, assign reference designator, add a part; and delete a part, if the user selects one of the displayed parts as the selected part; and
means for deleting the selected part and any associated lower level part of the selected part from the BOM, if the user selects the delete a part option.

15. A computer system according to claim 14, wherein said means for closing the BOM comprises:
means for prompting the user as to whether or not the BOM is to be saved;
means for prompting the user to enter a filename for the BOM and saving the BOM, if the user indicates that the BOM is to be saved; and
means for closing the BOM without saving the BOM, if the user indicates that the BOM is not to be saved.

16. A computer system according to claim 14, wherein the part information includes a description of the part, an original equipment manufacturer's part number for the part, a cage code relating to supplier information regarding the part, a supplier name for the part, an inspection code concerning inspection of the part, a unit cost for the part, a REC code indicating whether the part is repairable, consumable, non-repairable or expendable, LEAD time indication how far in advance the part should be ordered, a number of an acceptable replacement part, and a sample picture of the part.

17. A computer system for organizing parts in a hierarchy of levels as a bill of materials (BOM), said computer system comprising:
means for prompting a user to enter a filename of a spreadsheet containing a list of a plurality of parts, a number of each of the plurality of parts, and an associated hierarchal level of each of the plurality of parts;
means for checking the list of the plurality of part for errors;
means for displaying an error message, if at least one error exists in the spreadsheet; and
means for creating the BOM associating all of the plurality of parts in a hierarchy by associating each of the plurality of parts with at least one other of the plurality of parts based on the associated hierarchical level and an order in which the plurality of parts is listed in the list and to display the plurality of parts in the hierarchy, if no errors exist.

18. A computer system for verifying an assembly of a plurality of assets, said computer system comprising:
means for receiving a plurality of asset numbers, each of the asset numbers corresponding to one of the plurality of assets such that the plurality of asserts are arranged in a hierarchical order;
means for comparing a part number associated with each of the plurality of assets against a bill of materials having a plurality of part numbers in a hierarchy;
means for determining if any of the plurality of assets are inconstant with the plurality of parts in the BOM; and
means for displaying the inconsistencies, if any inconsistences exist.
